(19) United States
(12) Patent Application Publication
(10) Pub. No.: US 2018/0370694 A1
(43) Pub. Date: Dec. 27, 2018

(54) METHOD OF FORMING A METAL CLOSURE AND CLOSURE FOR CONTAINER

(71) Applicant: THREADLESS CLOSURES LIMITED, Ketton (GB)

(72) Inventors: Anthony Henry Joseph FRASER, Ketton (GB); John HEIN, Menston (GB)

(21) Appl. No.: 16/063,873

(22) PCT Filed: Dec. 15, 2016
(86) PCT No.: PCT/GB2016/053945

§ 371 Date: Jun. 19, 2018

(30) Foreign Application Priority Data
Dec. 21, 2015 (GB) 1522544.4

(51) Int. Cl. B65D 43/02; B67B 3/20; B67C 3/02; B67C 7/00

(52) U.S. Cl. CPC B65D 43/0283; B67B 3/20; B67C 3/02; B65D 2543/00972; B65D 2543/00092; B65D 2543/0024; B65D 2543/00277; B67C 7/00

(57) ABSTRACT

A method of forming a releasable closure for a container (10) having a circular opening (10A, 21B, 21), the method comprising releasably securing (23) an annular skirt portion (21) of the closure to a neck portion of the container (10), eg by means of a thread, subsequently locating a separate closing portion (22) of the closure over an opening (10A, 21B, 21) in the skirt portion (21), and irreversibly securing (23) the closing portion (22C, 22) to the skirt portion (21), eg by seaming, to form a closure that closes the opening (10A, 21B, 21) of the container (10) but is releasable therefrom by unscrewing the skirt portion (21) from the neck portion of the container (10). A closure comprising two, initially separate, components is also described: an annular skirt portion (21) and a closing portion (22C, 22) which can be irreversibly secured to the skirt portion (21) after the annular skirt portion (21) has been releasably secured to the neck portion of a container (10). An intermediate product comprising a container (10) having an annular skirt portion (21) of a releasable closure releasably secured to a neck portion thereof is also described as well as a method of filling a container (10) comprising the steps of providing a container (10) having an annular skirt portion (21) of a releasable closure releasably secured thereto, filling the container (10) through an opening (10A, 21B, 21) in the skirt portion (21) and subsequently locating a separate closing portion (22) of the closure over the opening (10A, 21B, 21) in the skirt portion (21), and irreversibly securing (23) the closing portion (22C, 22) to the skirt portion (21) so as to form a closure that closes the opening (10A, 21B, 21) of the container (10) but is releasable therefrom. The opening (10A, 21B, 21) of the annular skirt portion (21) may simulate the opening (10A, 21B, 21) of a conventional can body and the closing

### FIELD OF THE INVENTION

This invention relates to a method of forming a closure for a container having an opening, in particular a metal closure for a beverage container. The invention also relates to a closure formed by the method and to a container having such a closure and to an intermediate product in the formation of such a container and to a method of filling such a container. The container may be of a variety of sizes and may, for example, be a wide-mouth container or it may be a bottle. In some cases, it may be designed for containing a carbonated beverage.

### BACKGROUND ART

Containers and closures for wide-mouth containers and bottles are known such as those described in the applicants earlier applications, for example WO2006/000774 and WO2011/151630. Further developments are disclosed in co-pending applications PCT/GB2015/052154 (WO 2016/012810) and GB1518819.6 which describe one-piece closures, thread forms by which these may be secured to a container and preferred forms and materials of the closure. These prior developments seek to provide a closure capable of securely closing a container, in particular a wide-mouth container, the contents of which may be at an elevated pressure, eg during transportation and/or when subject to elevated temperatures, whilst remaining relatively easy for a consumer to remove.

Metal containers or cans for housing beverages are also known, for instance a conventional ring-pull can. Such cans are generally manufactured with an open end, through which it can be filled with a beverage, and the end of the can is subsequently secured, eg by a seaming process, to the body of the can. Similar cans are also known having a relatively narrow diameter screw threaded closure within the can end in place of the ring pull.

Whilst the closures described in the above documents are satisfactory in many cases, the present invention seeks to provide further improvements which assist in the manufacture of the container and/or the closure and/or the filling of the container, eg with a beverage, and the subsequent closure of the container.

### SUMMARY OF INVENTION

According to a first aspect of the invention, there is provided a method of forming a releasable closure for a container having a substantially circular opening, the method comprising releasably securing an annular skirt portion of the closure to a neck portion of the container, subsequently locating a separate closing portion of the closure over an opening in the skirt portion, and irreversibly securing the closing portion to the skirt portion so as to form a closure that closes the opening of the container but is releasable therefrom by disengaging said skirt portion from the neck portion of the container.

Preferably, the skirt portion of the closure and the neck of the container have mutually engageable thread forms whereby the closure can be releasably secured to the container by rotation relative thereto, preferably through less than 360 degrees, about an axis A through the container opening.

In a preferred embodiment the closure is formed of metal and the closing portion is irreversibly secured to the skirt portion by a seamed joint.

In a preferred form of the invention, material is passed into the container after the skirt portion has been releasably secured to the container neck and prior to the closing portion being irreversibly secured to the skirt portion.

According to a second aspect of the invention there is provided a closure for releasably closing a substantially circular opening of a container, the closure comprising two, initially separate, components: an annular skirt portion adapted to be releasably secured to a neck portion of the container and a closing portion adapted to be irreversibly secured to the skirt portion so as to close an opening therein after the annular skirt portion has been releasably secured to the neck portion of a container. The opening of the annular skirt portion preferably simulates the opening of a conventional can body and the closing portion is preferably of similar form to the can end applied to a conventional can body so that the closing portion can be irreversibly secured to a skirt portion that has been releasably secured to the neck portion of a container in a conventional can filling and closing line. The skirt portion of the closure and the neck of the container preferably have mutually engageable thread forms whereby the closure can be releasably secured to the container by rotation relative thereto and preferably through less than 360 degrees.

The thread forms preferably comprise a plurality of circumferentially spaced first projections on the container neck and a plurality of circumferentially spaced second projections on the skirt portion, each the first and second projections comprising a substantially horizontal part, the second projections on the skirt portion being able to pass between the first projections on the container neck and then locatable beneath the first projections on the container neck.

At least some of the second projections preferably have a downwardly inclined part at a first end of the horizontal part and/or an upwardly inclined part at a second end of the horizontal part such that upon rotation of the closure relative to the container in a first direction, said downwardly inclined parts act to drive the closure downwards relative to the container and/or upon rotation of the closure relative to the container in a second direction, said upwardly inclined parts act to drive the closure upwards relative to the container.

In a preferred embodiment, the closure is formed of metal.

The closing portion is preferably irreversibly secured to the skirt portion by a seamed joint and the seamed joint may be formed between an upstanding part of the skirt portion and a substantially circular edge part of the closing portion.

The skirt portion of the closure is preferably releasably secured to the container at a location having a diameter greater than or substantially equal to the diameter of the location at which the closing portion is irreversibly secured to the skirt portion.

In a preferred arrangement, the skirt portion of the closure has an o-ring seal located within a groove formed therein and arranged to provide a seal between the skirt portion and an external surface of the container neck when the skirt portion is releasably secured to the container neck.

The skirt portion of the closure may have a bore member which projects into the container opening when the skirt portion is releasably secured to the container neck and has an o-ring seal located within a groove formed in the bore member and arranged to provide a seal between the skirt portion and an internal surface of the container neck when the skirt portion is releasably secured to the container neck.

The closure is preferably moveable relative to the container between a first secured position thereon in which it is in sealing engagement with the container and a second secured position thereon in which venting of the container can occur.

The closure may have a plurality of third circumferentially spaced projections arranged to engage beneath the first projections on the container neck once the second projections have disengaged therefrom and the closure has move upwards relative to the container to release the sealing engagement therebetween.

The invention also relates to a closure as described above when releasably secured to a container which has been filled with a material. The container is preferably formed of metal or a plastics material.

According to another aspect of the invention, there is provided a container having a substantially circular opening and having an annular skirt portion of a releasable closure releasably secured to a neck portion of the container, the container being finable through an opening in the skirt portion, the skirt portion being adapted to have a closing portion irreversibly secured thereto, after the container has been filled, so the closure closes the opening of the container but is releasable therefrom by disengaging said skirt portion from the neck portion of the container. The opening of the skirt portion may be designed to simulate the opening or mouth of a conventional can so that the container with skirt portion releasably secured thereto can be filled and closed on a conventional filling and closing line as used in the canning industry.

The skirt portion of the closure and the neck of the container preferably have mutually engageable thread forms whereby the closure is releasably secured to the container by rotation relative thereto and preferably through less than 360 degrees.

In a preferred arrangement, the thread forms comprise a plurality of circumferentially spaced first projections on the container neck and a plurality of circumferentially spaced second projections on the skirt portion neck, each the first and second projections comprising a substantially horizontal part, the second projections on the skirt portion being able to pass between the first projections on the container neck and then locatable beneath the first projections on the container neck.

Such a container may also be provided with a tamper evident feature comprising one or more blocking members locatable in one or more gaps between said first projections once said second projections are located beneath said first projections so as to prevent said second projections from being aligned with and/or passing through said gaps until the blocking feature is moved out of said one or more gaps.

The container and the skirt portion of the closure may be formed of metal.

Alternatively, the container may be formed of a plastic material and the skirt portion of the closure formed of metal.

According to a further aspect of the invention there is provided a method of filling a container comprising the steps of providing a container having a substantially circular opening and having an annular skirt portion of a releasable closure releasably secured to a neck portion of the container, filling the container through an opening in the skirt portion, subsequently locating a separate closing portion of the closure over the opening in the skirt portion, and irreversibly securing the closing portion to the skirt portion so as to form a closure that closes the opening of the container but is releasable therefrom by disengaging said skirt portion from the neck portion of the container. Such a method of filling may be carried out on a conventional filling and closing line.

The diameter of the container opening may preferably be in the range 45 to 80 mm.

The opening of the skirt portion may have a diameter of at least 80% of the diameter of the container opening.

As mentioned above, the closure is preferably formed of metal. Forming the closure of metal enables the wall thickness, and hence the amount of material used to form the closure to be reduced, thus reducing its weight and/or cost compared to a plastics closure. A metal closure can be fabricated in a variety of ways and, in particular, can be formed and shaped by one or more pressing operations. Thus, rather than requiring a relatively complex three-dimensional shape formed by injection moulding (as with a plastic closure), it is possible to form the closure from a single, flat sheet of metal.

A metal closure also has excellent gas barrier properties as it is essentially impermeable to both oxygen and carbon dioxide even at elevated temperatures. A metal closure can also be readily recycled. A metal closure also does not soften when subject to elevated temperatures, eg during pasteurisation, so is less likely to move or deform in such circumstances. Such movement or deformation of a plastic closure can make it more difficult to ensure a satisfactory seal between the closure and the container is maintained at elevated temperatures.

As mentioned above, the means for securing the skirt portion of the closure to the container comprises a projection extending around the circumference of each part comprising a series of substantially horizontal, circumferentially spaced apart elements arranged such that the elements on the metal closure can pass though the spaces between the elements on the container and located beneath them to secure the metal closure to the container. The elements of the projection on the container are separated from each other in the circumferential direction and do not overlap with each other in the vertical direction. Similarly, the elements of the projection on the metal closure are separated from each other in the circumferential direction and do not overlap with each other in the vertical direction.

Preferably, each of the second portions has an upwardly inclined end at one end thereof and/or a downwardly inclined end at the other end thereof. The upwardly and/or downwardly inclined ends of the second portions preferably extend beyond said elongate upper and lower surfaces thereof, respectively.

Preferably, upon rotation of the closure in a first direction about axis A, said downwardly inclined ends acts to drive the second portions downwards relative to the first portions and upon rotation of the closure in a second direction about axis A, said upwardly inclined ends acts to drive the second portions upwards relative to the first portions.

Preferably, said downwardly inclined ends act to drive the second portions downwards from a position in which a sealing member contacts the container in a non-sealing position to a position in which the sealing member sealingly engages a sealing surface of the container.

Preferably, the closure is also movable between a first secured sealed position and a second secured venting position in which venting of the container is enabled.

In a preferred arrangement, particularly for use for housing a carbonated beverage, the skirt portion of the closure comprises a further inwardly projecting member comprising a plurality of circumferentially spaced apart third portions, each of the third portions having an upper surface which is at a lower level than said upper surfaces of the second portions, said third portions being arranged to engage the lower surfaces of the first portions (on the container) when the metal closure is in a venting position, ie said third portions are arranged to engage the lower surfaces of the first portions when the metal closure is in said second position.

As mentioned, the sealing member preferably comprises an o-ring provided within a recess in the skirt portion of the closure and the sealing surface is an internal or external surface of the container. The term o-ring as used herein is to be understood to include a toroid of elastomer material having a circular cross-section (or other cross-sections). Such o-rings are conventionally located in a gland (which may typically be defined by a groove or by a recess having two or more faces). The cross-sectional area of the o-ring is preferably smaller than the cross-sectional area of the gland so, when the metal closure is mounted on the container, the o-ring is able to move and/or deform within the gland. The o-ring can therefore move or deform within the gland so as to be able to seal more tightly with the sealing surface in response to a pressure differential between the interior and exterior of the container (as described in WO 2011/151630 referred to above). The o-ring is preferably formed of nitrile butadiene rubber (NBR). Further details are given in WO2011/151630 referred to above.

Further preferred and optional features of the invention will be apparent from the following description and the subsidiary claims of the specification.

### BRIEF DESCRIPTION OF THE DRAWINGS

Embodiments of the present invention will now be described, merely by way of example, with reference to the accompanying figures, in which:

FIG. 1 is a perspective view of a skirt portion of a first embodiment of a closure according to one aspect of the invention;

FIG. 2 is a perspective view of an upper part of a container adapted to receive a skirt portion such as that shown in FIG. 1;

FIG. 3 is a cross-sectional view of the skirt portion of FIG. 1 when releasably secured to a neck portion of the container shown in FIG. 2;

FIG. 4 is a perspective view of a closing portion of the closure prior to it being connected to the skirt portion;

FIG. 5 is similar to FIG. 3 but also shows the closing portion of FIG. 4 of the closure located over an opening of the skirt portion;

FIG. 6 is similar to FIG. 5 showing the closing portion once it has been irreversibly secured to the skirt portion to complete the closure;

FIG. 7 is a perspective view of the closure and container as shown in FIG. 6;

FIG. 8 is a perspective view of a skirt portion of a second embodiment of a closure according to one aspect of the invention;

FIGS. 9 to 11 are cross-sectional views corresponding to those of FIGS. 3, 5 and 6 of the skirt portion of FIG. 8 when releasably secured to a neck portion of a container such as that shown in FIG. 2;

FIG. 12 is a perspective view of the closure and container as shown in FIG. 11;

FIG. 13 is a perspective view of a skirt portion of a third embodiment of a closure according to one aspect of the invention;

FIG. 14 is a perspective view of an upper part of another form of container adapted to receive a skirt portion such as that shown in FIG. 13;

FIGS. 15 to 17 are cross-sectional views corresponding to those of FIGS. 3, 5 and 6 of the skirt portion of a closure of FIG. 13 when releasably secured to a neck portion of a container as shown in FIG. 14 and FIG. 18 is a perspective view of the closure when secured to the container in the position shown in FIG. 17;

FIG. 19A is a cross-sectional view similar to that of FIG. 3 showing the skirt portion of a modification of the first embodiment secured to a neck portion of a container, FIG. 19B is a similar view once the top part of the closure has been secured to the skirt part and FIG. 19C shows the closure once it has moved from the sealed position in FIG. 19B to a venting position.

The figures illustrate different embodiments of a closure which is formed by a skirt portion which is first secured to the neck of a container and a closing portion that is subsequently irreversibly secured to the skirt portion so as to complete the closure (typically after the container has been filled, eg with a beverage or some other foodstuff or other material).

With known removable closures on narrow mouth container such as bottles, the filling technique intentionally creates a froth (known as fob) which is used to expel air form a headspace above the liquid beverage and, as the container neck is relatively narrow, the filling process can be accurately controlled to minimise over-fill or spillage (so such filling lines do not usually have a rinsing station to rinse the container neck prior to fitting a closure to the container). With a wide mouth container this is much more difficult to achieve as filling within 10 mm of the brim is likely to cause overflowing and contamination of the threads on the container neck so rinsing would be required prior to fitting the closure. The alternative is to fill in a manner which does not cause fobbing but if no fob is created, air is not excluded from the headspace so the contents are exposed to oxidation.

For beverages stored in cans a different filling technique is used. Carbon dioxide is pumped into the body of the can and air and carbon dioxide sucked out in a series of cycles in order to remove oxygen from the can whilst the body of the can is filled with liquid beverage in a non-frothing manner. Alternatively, the can is filled with liquid beverage and the level of frothing is controlled by flushing with carbon dioxide together with a ‘bubble breaking’ method (using jets of liquefied gas). Once the can is full, the end of the can is immediately secured to the end of the can body, eg by a seaming operation. A typical can filling line thus has both a filler (with associated gas flushing apparatus) and a seaming station for immediately attaching the end of the can to the can body to form a closed container with minimal oxygen therein.

A significant advantage of the present invention is to make use of such a can filling and closing line to create a container having a closure releasably secured thereto and, in particular a wide mouth closure. The opening in the skirt portion of the closure simulates the opening of a body of a conventional can and the closing portion of the closure is of similar form to the can end applied to a conventional can body. Thus, the invention exploits the fact that a conventional can filling line is combined with a seamer to close the can immediately after it has been filled by providing a particular form of container which can be filled and closed in the same way yet provides a container with a releasable wide-mouth closure. The container with skirt portion secured thereto can therefore be filled and the closing portion secured thereto in a conventional can filling and closing line with little or no modification of the line.

The invention thus enables a container having a releasable closure (and preferably a wide mouth closure and/or a closure which can be re-fitted after removal), to be filled on a conventional can filling line and for the container to be closed by using the seaming apparatus to irreversibly secure a closing portion to the skirt portion so as to complete formation of the releasable closure.

As mentioned, the closing portion can be irreversibly secured to the skirt portion by a seamed joint, ie the same technology as used to secure the end of a conventional beverage can (such as a ring-pull can). The invention thus enables an improved form of container (ie a with mouth container with a releasable closure and, optionally, re-sealable closure) to be compatible with existing can filling and closing lines with little or no modification. This avoids the need for significant capital investment in new or extensively modified manufacturing plant and so enables an improved form of container, such as a beverage container, to be manufactured without the need for capital investment in new manufacturing apparatus.

The closure preferably has a threadform similar to that described in co-pending PCT/GB2015/052154 and as described below in relation to the embodiments shown in the drawings. Other threadforms or bayonet type arrangements can be used (but will not have the additional advantages of those described in PCT/GB2015/052154).

The closure also preferably has sealing means in the form of an o-ring as disclosed in WO2011/151630 and in PCT/GB2015/052154. In some embodiments the o-ring may engage a sealing surface around the exterior of the neck portion of the container whereas in other embodiment the o-ring may engage a sealing surface around an internal surface of the neck portion of the container.

It will be appreciated that when the container is filled on a conventional can filling and closure line (as discussed above), it is important that a good seal is provided between the skirt portion of the closure and the container (both during the filling operation and in the finished closed container). The use of an o-ring seal is particularly advantageous for providing such a seal when the container is to contain a carbonated beverage (or other pressurised contents).

The o-ring is preferably mounted in a groove in the skirt portion of the closure or in a bore member which projects into the mouth of the container. The bore member is preferably part of the skirt portion but other arrangements in which it is part of the closing portion can also be envisaged. Other forms of sealing member for proving a seal between the closure and the container can be used (particularly in applications in which elevated pressures within the container do not need to be catered for).

If the container is designed to contain a carbonated beverage (or other pressurised contents), the closure is also preferably designed to be movable between a first secured and sealed position to a second secured venting position (in which the contents can vent but the closure remains attached to the container) and then to an open position. Other forms of venting may however be used.

Securement of the skirt portion to the neck of the container by means of a thread form such as that of PCT/GB2015/052154 will be described below. Further description of assembly of the closing portion onto the skirt portion will then be provided.

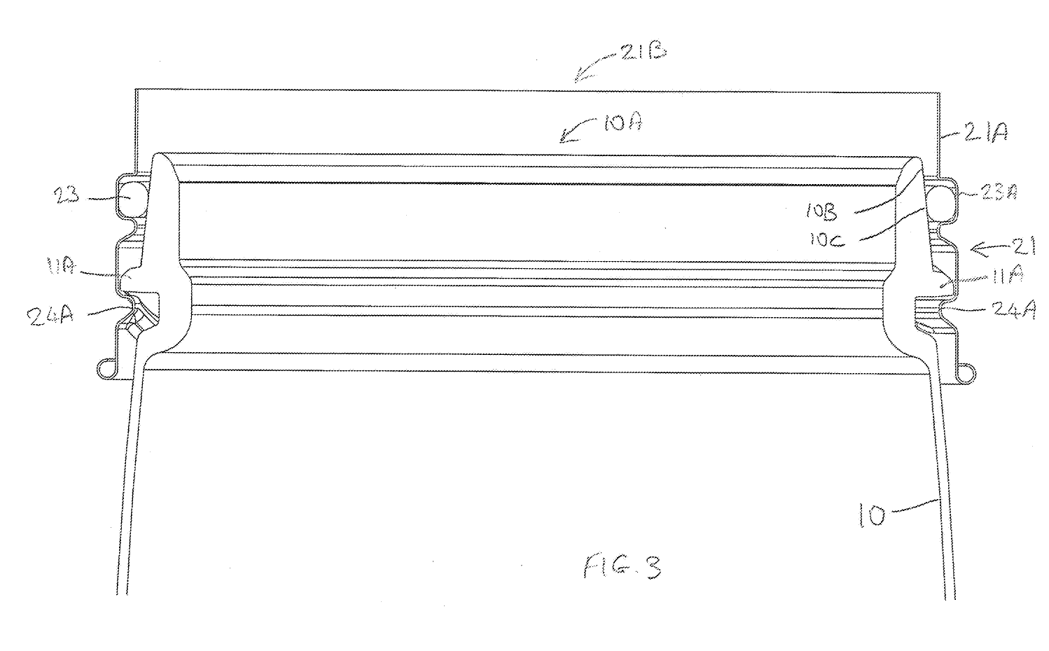

FIG. 2 shows a wide-mouth container 10 used in a first embodiment of the invention. The container has an opening 10A defining an axis A and has an outwardly projecting first member around an external surface of the container 10, the first member comprising a plurality of circumferentially spaced apart first portions 11A (four in the example shown), each first portion 11A has an upper surface 11B, a lower surface 11C, a first end surface 11D and a second end surface 11E. The upper surface 11B is substantially horizontal in the circumferential direction but may be curved or inclined in the radial direction. The lower surface 11C is also substantially horizontal in the circumferential direction and, in the embodiment shown, is substantially horizontal, and substantially flat, in the radial direction. The shape and function of the end surfaces will be described below. Further description of this threadform is also provided in co-pending application PCT/GB2015/052154.

The spaced apart portions of the first member form an intermittent, outwardly projecting lip which may be located at or near the upper end of the container 10 or, as in the embodiment shown, spaced from the upper end of the container 10, eg by a distance in the range 9-12 mm. The first portions 11A are separated from each other in the circumferential direction and do not overlap with each other in the vertical direction.

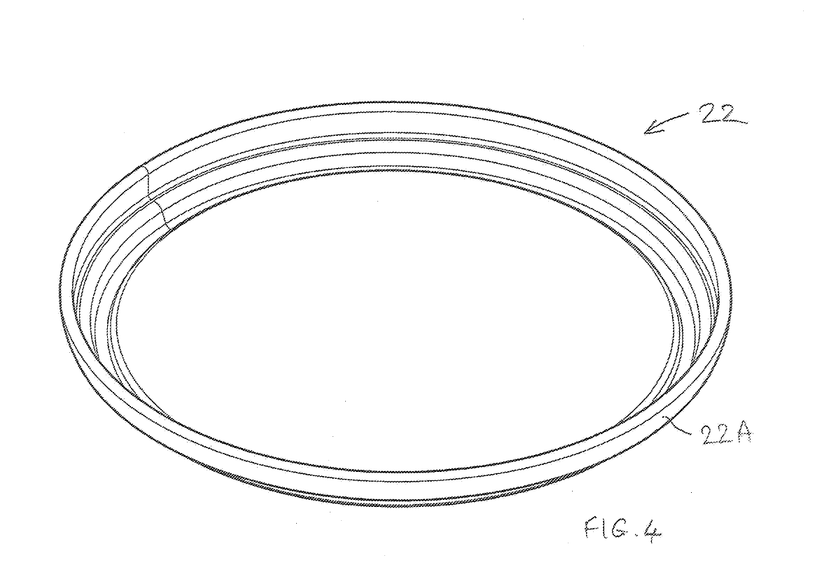

Preferably, as shown in FIGS. 2 and 3, the uppermost portion 10B of the external surface of the container is inclined to axis A so as to provide a lead-in surface to compress/deform the o-ring as the skirt portion of the closure is drawn downwards relative the container. The inclined surface leads to a sealing surface 10C which may also be inclined to the axis A (as shown) or may be a substantially parallel sided, cylindrical portion of the external surface of the container 10. In some embodiments a plurality of venting grooves or passages (not shown) may be provided at spaced apart positions around the circumference of the lead-in surface to facilitate venting of the container.

The container shown in FIG. 2 also has a handling groove 15 in the external surface thereof to facilitate handling of the closure as it passes through automatic machinery, eg during manufacture and subsequent processes such as washing, filling, closing etc. In other embodiments (not shown), the handling groove may not be required.

In some embodiments, the container may be formed of a plastics material, eg polyethylene terephthalate (PET), and is typically formed in a two-stage moulding process: forming a preform in a first injection moulding stage which forms the features above the groove 15 and then a second blow moulding stage in which the preform is blown to form the container shape beneath the groove 15. The first portions 11A and/or the groove 15 may be used to hold the preform during the blow moulding stage.

The container may also be formed of other materials, eg glass or metal or of a combination of materials. An example of a metal container is described in co-pending GB1518819.6. As mentioned above, a preferred form of the invention comprises a metal container with a metal closure, although a metal closure may also be provided on a container formed of another material, eg plastic or glass.

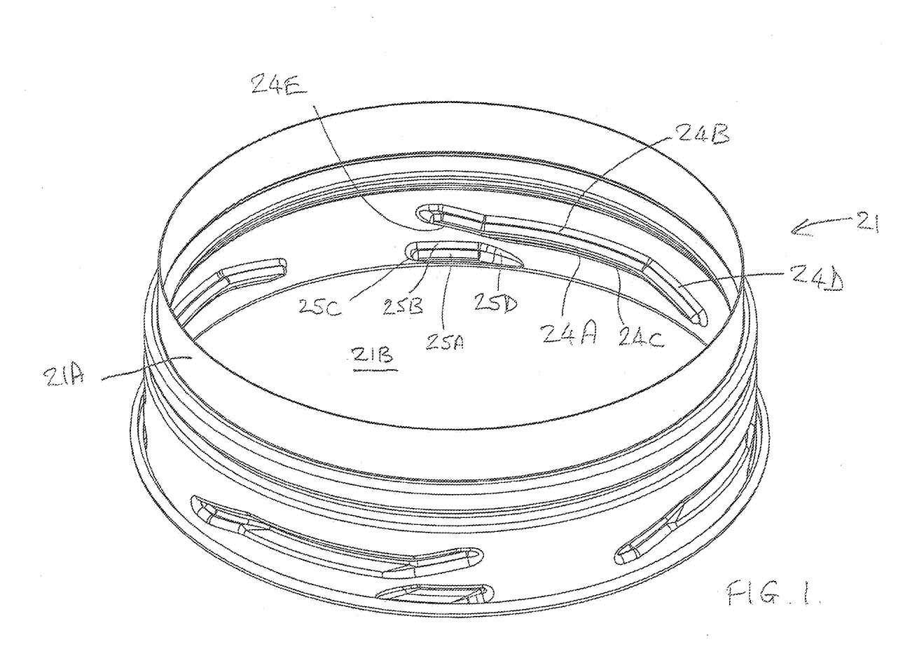

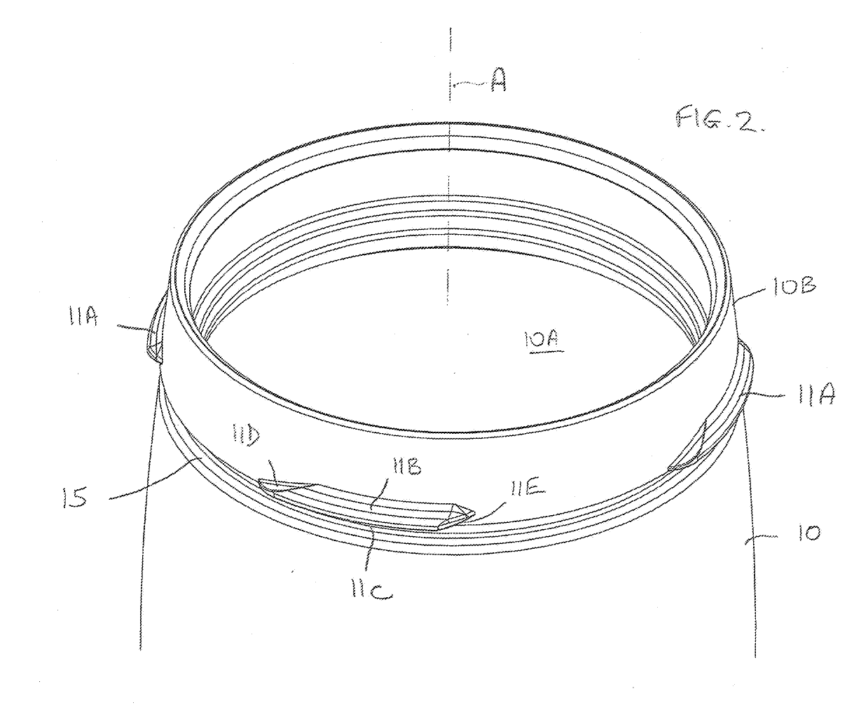

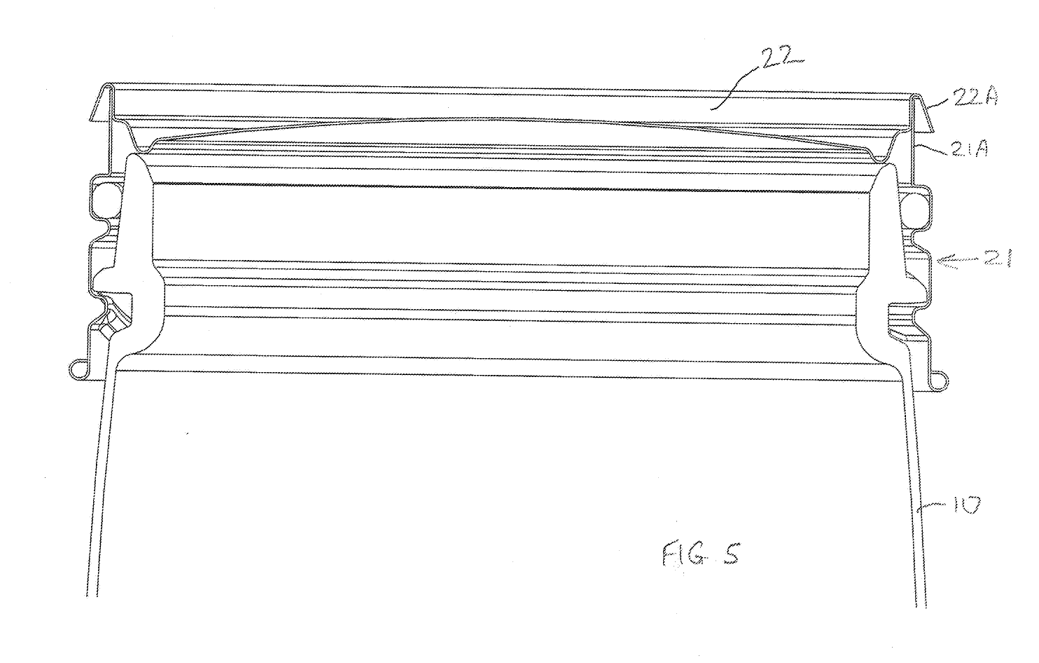

FIG. 1 shows a skirt portion 21 of a metal closure used in a first embodiment of the invention. The closure initially comprises the skirt portion 21 and a separate closing portion 22 as shown in FIG. 4. The skirt portion 21 carries a sealing member 23 (see FIG. 3), for example an o-ring, so that the sealing member 23 provides a seal between an external sealing surface 10C of the container 10 and the skirt portion 21 when the skirt portion 21 is mounted on the container 10 as shown in FIG. 3. The o-ring 23 is located in a groove or gland 23A provided in the inner surface of the skirt portion 21.

Further details of a suitable form of o-ring and gland are provided in WO2011/151630 referred to above. It should be noted that the walls of the gland should be smooth to ensure a satisfactory seal and forming the closure of metal enables this to be easily achieved. The o-ring for a wide-mouth closure may typically have a cross-sectional diameter of 2 to 3 mm. The sealing surface 10C has an axial length sufficient to accommodate some vertical movement of the o-ring 23 relative to the container 10 (eg due to pressure variations in the container).

The skirt portion 21 of the closure is also provided with an inwardly projecting second member around an internal surface thereof, said second member comprising a plurality of circumferentially spaced apart second portions 24A (four in the example shown) as shown in FIG. 1. Each of the second portions has an upper surface 24B, a lower surface 24C, a downward angled end with a first end surface 24D and an upward angled end with a second end surface 24E. The upper surface 24B is substantially horizontal in the circumferential direction and may be substantially horizontal (and substantially flat) in the radial direction or it may be curved in the radial direction. The lower surface 11C is also substantially horizontal in the circumferential direction but may be curved or inclined in the radial direction. The end surfaces 24D and 24E are angled downwardly and upwardly, respectively, in the circumferential direction and, in the embodiment shown, these surfaces extend beyond the lower and upper surfaces 24C and 24B of the second portion 24A, respectively. The function of the angled ends and end surfaces 24D and 24E will be described further below.

In the embodiment shown, a further inwardly projecting member is provided on the skirt portion comprising a plurality of circumferentially spaced apart third portions 25A. Each of the third portions also has an upper surface 25B which is substantially horizontal in the circumferential direction and may be substantially horizontal (and substantially flat) in the radial direction or may be curved in the radial direction. The upper surfaces 25B are at a lower level than the upper surfaces 24B, the vertical spacing between the upper surfaces 24B and 25B typically being around 2.5-4.0 mm. The third portions 25A also have angled or curved end faces 25C and 25D.

As shown, the second portions 24A are also separated from each other in the circumferential direction and do not overlap with each other in the vertical direction.

The third portions 25A are also separated from each other in the circumferential direction and do not overlap with each other in the vertical direction, although they may overlap, at least to some extent, with the second portions 24A in the vertical direction.

As described in more detail in PCT/GB2015/052154, the skirt portion of the closure is securable to the container 10 by interaction between the first portions 11A and second portions 24A referred to above as described below.

The following description refers to the initial mounting of the skirt portion 21 (prior to securement of a closing portion 22 thereto). Once the closure has been completed by irreversibly securing the closing portion 22 to the skirt portion 21 (as described further below) and following removal of the closure from the container 10 by a user, the closure can subsequently be re-mounted on the container 10 to close it again. This involves the same sequence of interactions between the thread features (first portions 11A and second portions 24A) of the skirt portion ands the container described below.

In the arrangement shown, the skirt portion 21 of the closure is movable between a first position in which the second portions 24A (or at least part of the second portions) engage the upper surfaces 11B of the first portions 11A, a second position (following rotation and downward movement of the closure relative to the container 10), in which the sealing member 23 contacts the container 10 in a non-sealing position and the second portions 24A are aligned with spaces between the first portions 11A, and a third position (corresponding to the position shown in FIG. 3), following further rotation and further downward movement of the closure relative to the container 10, in which the sealing member 23 has been moved downwards to sealingly engage the sealing surface 10C of the container and the second portions 24A are located beneath the first portions 11A and in contact with substantially the entire circumferential length of the lower surfaces 11C thereof.

Mounting the skirt portion 21 on the container thus involves the following stages: the second portions 24A are initially located above the first portions 11A and are then moved so they pass through the spaces between the first portions 11A and finally to a position in which they are located beneath the first portions 11A. The upper surfaces 24B of the second portions 24A are substantially horizontal and substantially flat throughout their length (or at least between the inclined ends 24D and 24E of the second portions 24A), so they can slide horizontally beneath the lower surfaces 11C of the first portions 11A, the lower surfaces 11C also being substantially horizontal and substantially flat throughout their length (or at least between the ends 11D and 11E of the first portions 11A).

To release the skirt portion 21 (typically following completion of the closure by the securement of the closing portion 22 to the skirt portion 21) from the secured position, it is rotated relative to the container 10 so as to disengage the second portions 24A from the underside of the first portions 11A and is then moved upwards. In a simple arrangement without further means to hold the closure in a venting position, the closure can then be lifted away from the container 10. In other arrangements, further rotation will be required to in order to release the closure from a venting position.

As described above, in the secured position, the second portions 24A are located beneath the first portions 11A and, to release the closure it is necessary to move the second portions so they are aligned with the gaps between the first portions 11A so they can pass though these gaps. Accordingly, if it is desired to prevent removal of the closure and/or provide a tamper evident feature, this can be achieved by inserting a blocking feature (not shown) into one or more of the gaps between the first portions 11A to prevent the second portions 24A being moved into alignment with said gaps and/or pass through said gaps until the blocking feature has been moved out of the way.

Such a blocking feature can be provided in a variety of ways. It may, for example, be attached to the closure or may be separate therefrom. It may be arranged so that when sufficient torque is applied thereto it ruptures and/or moves radially outwards so it no longer blocks movement of the second portion 24A into alignment with the gaps between the first portions 11A. In some cases, the blocking feature is positioned such that if the closure begins to be rotated in the loosening direction, the second portion 24A engages one side of the blocking features which blocks further rotation of the second portion 24A. If the blocking feature has a width similar to the length of the gap between the first portions 11A, circumferential movement of the blocking feature in the loosening direction may also be prevented by another side of the blocking feature engaging an end a first portion 11A.

Referring back to FIG. 2, it will be noted that the first portions 11A have inclined end surfaces 11D and 11E. Preferably, these lie at approximately 45 degrees to the horizontal, although other angles may be used. The end surface 11D may extend from the upper surface 11B to the lower surface 11C. However, the end surface 11E may not extend all the way from the lower surface 11C to the upper surface 11B. The end surfaces 11D and 11E of the first portions may also have other forms.

And, as described in relation to FIG. 1, the second portions 24A have inclined ends with end surfaces 24D and 24E which extend beyond the lower and upper surfaces 24C and 24B. The function of the inclined ends will be described further below.

As mentioned above, the third portion 25A (shown in FIG. 1) is provided in a closure intended for use with a container housing a carbonated beverage and its function is to retain the closure on the container when in a venting position. The following description describes the sequence of interactions between the thread features of a skirt portion having such further portions 25A and the container when the skirt portion is mounted onto the container.

In a first pre-load stage the third portions 25A rest upon the upper surfaces 11B of the first portions 11A and in this position, the o-ring 23 may be spaced from the container 10. Following rotation of the closure about the axis A relative to the container 10 in the tightening direction (clockwise in the embodiment shown) from the first pre-load position, the third portions 25A drop down into the spaces between the first portions 11A until the downwardly angled ends of the second portions 24A rest upon the upper surfaces 11B of the first portions 11A. In this second pre-load position, the o-ring 23 may still be spaced from the container 10 (or only loosely in contact therewith).

Upon further rotation of the closure in the closing direction from this position, the second portions 24A slide along the upper surfaces 11B of the first portions 11A until the downwardly angled ends thereof drops off the end of the upper surface 11B and the lower surfaces 24C of the second portions 24A rest upon the upper surfaces 11B of the first portions 11A. In this position, the closure is slightly lower than in the previous position and the third portions 25A engage the underside of the first portions 11A.

Upon further rotation of the closure in the tightening direction, the second portions 24A slide along the upper surface of the first portions and the third portions 25A slide along the underside of the first portions 11A. This horizontal movement continues until the end surfaces 24D of the downwardly angled ends of the second portions (which, as mentioned above, preferably extend beyond the lower surfaces 24C) reach the end surfaces 11E of the first portions 11A. The second portions 24A are then aligned with the gaps between the first portions 11A.

In this position the o-ring is preferably in contact with the upper part 10B of the outer surface of the container 10 and the first portion 11A is sandwiched between the second portion 24A and third portion 25A. As will be described further below, this also corresponds to the venting position when the closure is being removed from the container.

The length of the second portions (in the circumferential direction), or at least the horizontal part thereof, is preferably substantially similar to (but slightly less than) the length of the spaces between the first portions 11A. This is necessary to enable the second portions 24A to move downwards through the space between the first portions 11A as will be described below.

Upon further rotation of the closure in the tightening direction, the inclined end surface 24D of the downwardly angled end of the second portions slide down the inclined end surfaces 11E of the first portions so the closure is driven downwards relative to the container as it rotated. Preferably, the end surfaces 24D and 11E are inclined at substantially the same angle, eg around 45 degrees in the embodiment shown, so the second portions 24A move downwards at this angle to the axis A. Rotation of the closure thus drives it downwards until the inclined end surface 24D of the second portions 24A disengage from the lower end of the inclined end surfaces 11E of the first portions 11A. The upper surface 24B of the second portions 24A is then level with the underside 11C of the first portions 11A. Upon further rotation from this position, the second portions 24A slide horizontally along the underside of the first portions 11A until the upwardly angled end having the end surface 24E (which extends beyond the upper surface 24A) engages the end surface 11E of the first portion and stops further rotation. In this position, the second portions 24A are located beneath the first portion 11A and the substantially horizontal upper surface 24B of the second portion 24A is in contact with substantially the entire length (in the circumferential direction) of the substantially horizontal underside 11C of the first portion 11A. The second portions 24A are thus securely located under the first portions 11A and the area of contact therebetween (which resists upward movement of the closure due to elevated pressures within the container) is maximised.

FIG. 3 shows a cross-section of a skirt portion 21 of a closure and container 10 in the secured position. As will be seen, the o-ring 23 has been driven downwards to sealingly engage the sealing surface 10C around the exterior of the container. This involves compression of the o-ring 23 and the above arrangement in which the downward movement of the closure which causes this is effected by rotation of the closure provides a significant mechanical advantage in providing the force required to compress the o-ring 23, particularly for a wide-mouth closure in which the closure has a relatively large diameter (eg compared to a bottle cap). The rotation required to drive the o-ring 23 down in this way may be through a relatively small angle (depending on the length and angle of the inclined end surface 11D) and may typically be in the range 5 to 15 degrees.

It will also be appreciated that the vertical distance by which the closure is driven downwards is determined by the angle and length of the end surfaces 24D and extension of the end surfaces 24D beyond the lower surface 24C enables the closure to be driven down a sufficient distance so the o-ring 23 is driven down from the lead-in surface 10B and into sealing engagement with the sealing surface 10C.

To release the closure from the secured position shown in FIG. 3 (after the closing portion has been secured to the skirt portion as describe below), the closure is rotated about the axis A in the loosening direction (anti-clockwise in the embodiment shown) relative to the container 10. Initially, the closure is rotated until the end face 24E of the upwardly angled end of the second portion 24A (which, as mentioned above extends beyond the upper surface 24B of the second portion 24A) contacts the end surface 11D of the first portions 11A. Then, upon further rotation from this position, the inclined end face 24E rides up the inclined end face 11D until the third portions 25A engage the underside of the first portions 11A to arrest the vertical movement of the closure. During this upward movement of the closure, the o-ring 23 moves from sealingly engaging the sealing surface 10C to a position in which it is located on the lead-in surface 10B.

Excess pressure within the container can then be released by escape of gas between the o-ring seal 23 and the lead-in surface 10B. The closure is, however, securely held on the container by the engagement of the third portions 25A with the underside of the first portions 11A and the first portion 11A is sandwiched between the second portion 24A and third portion 25A.

As the closure is rotated further in the loosening direction, the third portions 25A slide along the underside of the first portions 11A and the second portions 24A slide along the upper surface 24B of the first portions 11A until the downwardly angled end of the second portion that extends beyond the lower surface 24C thereof reaches the inclined end surface 11D of the first portion 11A. At the same time, the third portions 25A reach a position in which they disengage from the underside 11C of the first portions 11A (so no longer resist upward movement of the closure).

As the closure is rotated further, the upwardly angled end of the second portion rises up the inclined end surface 11D of the first portions 11A and an inclined side face 25B of the third portion 25A rides up the inclined end face 11E of the first portion 11A so the closure moves diagonally upwards. If the container houses a carbonated beverage, the pressure produced by this within container will assist this upward movement of the closure.

Upon further rotation of the closure, the third portion 25A is able to move upwards through the space between the first portions 11A and the closure is free to be lifted away from the container.

As described above, the inclined ends of the second portions 24A respectively serve to drive the closure downwards and upwards relative to the container and they also respectively act as stops to limit rotation of the closure clockwise and anti-clockwise relative to the container. Although the preferred arrangement has both downwardly and upwardly inclined end portions 24D and 24E to, respectively, drive the closure downwards and upwards, other arrangements may only have downwardly inclined ends and yet further arrangements may only have upwardly inclined ends.

For containers designed for use with a non-carbonated beverage, the area of overlap between the first and second portions in the secured position can be much reduced compared to embodiments for carbonated beverages as the upward pressure the closure needs to be able to withstand is much reduced. Nevertheless, it is still desirable to maximise the overlap between the first and second portions, ie by making them substantially the same length as each other in the circumferential direction, so the total circumferential length of the first portions can be minimised (and so minimise their impact on the user's lip) whilst still making full use of the amount of overlap possible (to ensure secure attachment of the closure and avoiding indentation damage to the first portions by the second portions.

The sub-assembly of a container with a skirt portion 21 of a closure releasably secured thereto as shown in FIG. 3 is, in effect, an intermediate product formed in the production of a filled and closed container. This intermediate product may be manufactured by one party, eg a container manufacturer, and passed to another party for filling and completion of the closure on the filled container.

Other features of the closure will now be described, in particular the fabrication of the closure from two initially separate parts: the skirt portion 21 (as shown in FIG. 1) and the closing portion 22 (as shown in FIG. 4). Both parts of the closure are preferably formed of metal and can be formed by pressing and/or rolling operations or other metal forming techniques. The skirt portion 21 may, for example, have grooves rolled in its outer surface to form projections 24A on the inner surface which provide the second portions 24A. The third portions 25A may also be formed by further grooves rolled in the outer surface to form projections 25A on the inner surface. Alternatively, the third portions 25A may be formed in the lower lip of the skirt portion, eg as it is turned upwards to provide a convex edge (as in conventional metal closures).

The wall thickness (gauge) of such a metal closure may typically be in the range 0.14 mm-0.24 mm. The metal used may be similar to that used in conventional metal closures, eg as used for other types of twist off caps, for example tinplate (a low carbon mild steel coated on both surfaces with an electrolytic deposition of tin). The metal closure may also be formed from aluminium sheet as used in known aluminium beverage containers and closures, for example as used for roll on pilfer-proof (ROPP) closures. The use of aluminium also enables the provision of a tamper evident band on the closure, for example a drop-band which separates from the closure as the closure is removed (and which could drop into the handling groove 15) or a split-band which is ruptured when the closure is removed and comes away with the closure

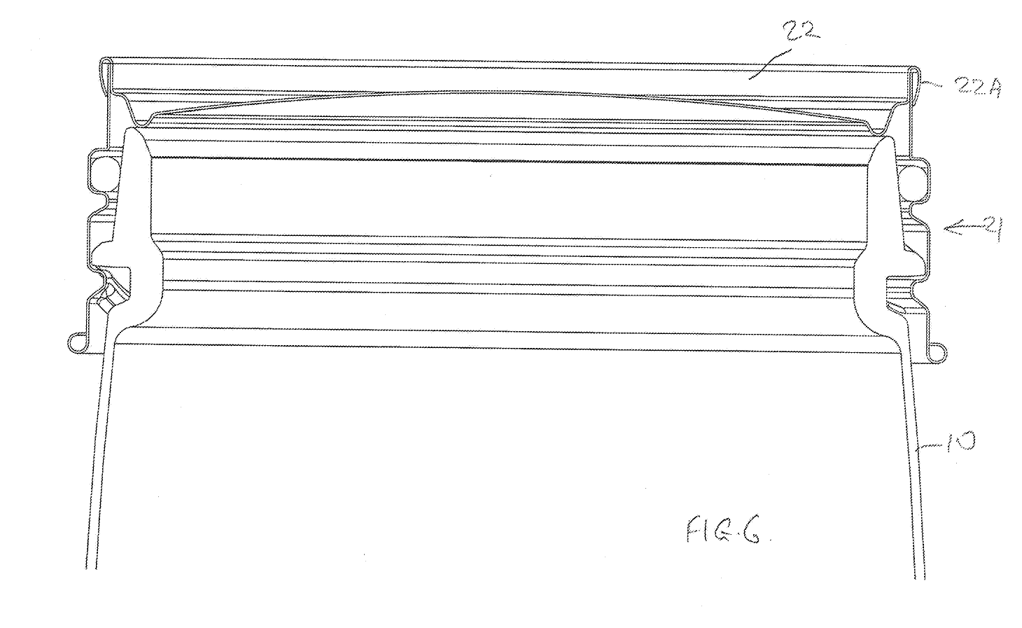

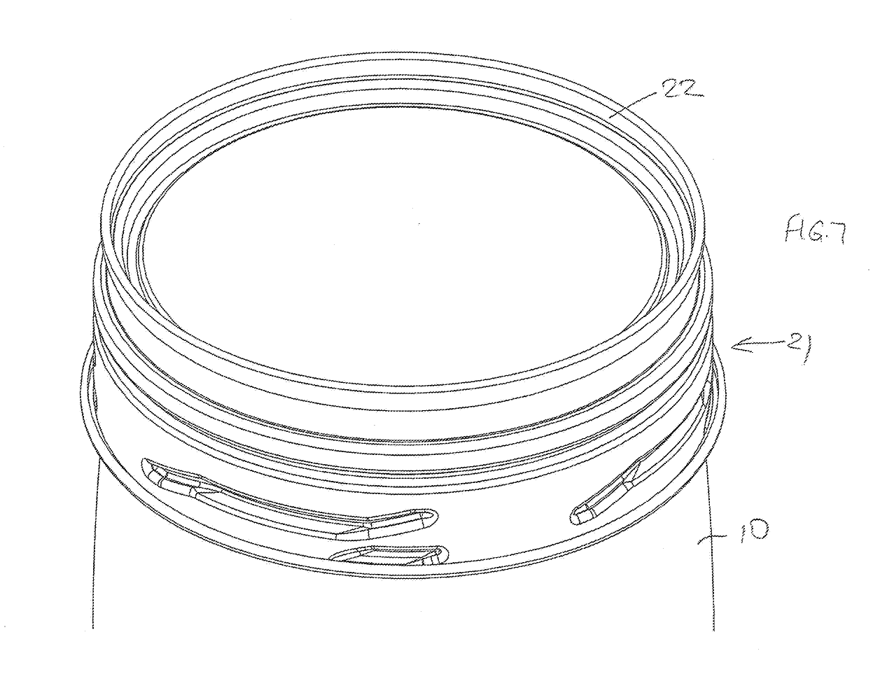

Once the skirt portion 21 has been releasably secured on the container as shown in FIG. 3, the closing portion 22 (as shown in FIG. 4) may be secured thereto. The closing portion 22 is located onto a substantially cylindrical upstanding part 21A of the skirt portion so as to close an opening 21B in the skirt portion 21 as shown in FIG. 5, eg by locating an angled flange 22A around the periphery of the closing portion 22 over the cylindrical upstanding part 21A of the skirt portion 21. Flange 22A may then be compressed in a seaming operation to form a seamed joint with the upstanding part 21A as shown in the cross-sectional view in FIG. 6. The closing portion 22 is thus irreversibly secured to the skirt portion 21 to complete the formation of the closure. As the skirt portion 21 has already been releasably secured to the container 10, the completed closure is formed so it is releasably secured to the container 10. FIG. 7 shows a perspective view of the completed closure secured to the container as in FIG. 6.

Other techniques may be used for irreversibly securing the closing portion 22 to the skirt portion 21, eg glueing or welding although seaming is preferred when the parts are made of metal as seaming is a widely used process in the canning industry.

As previously mentioned, the method described above for forming a releasable closure allows the skirt portion of the closure to first be fitted to the container, for the container to then be filled, eg with a beverage, through the opening 21B in the skirt portion 21, and the closing portion 22 to then be secured to the skirt portion 21, ie after the container has been filled. This novel method of forming the closure enables a novel form of container and closure to be filled and closed on a conventional can filling and closing line and enables a novel method of filling a container to be provided, ie a method in which a skirt portion of closure is releasably secured to a container prior to the container being filled and fabrication of the releasable closure completed (so as to close the container) after the container has been filled.

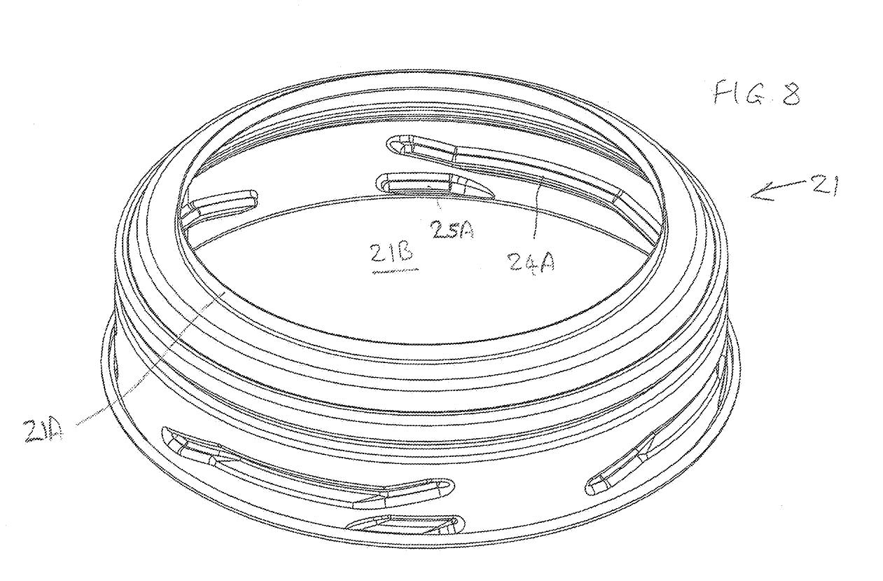

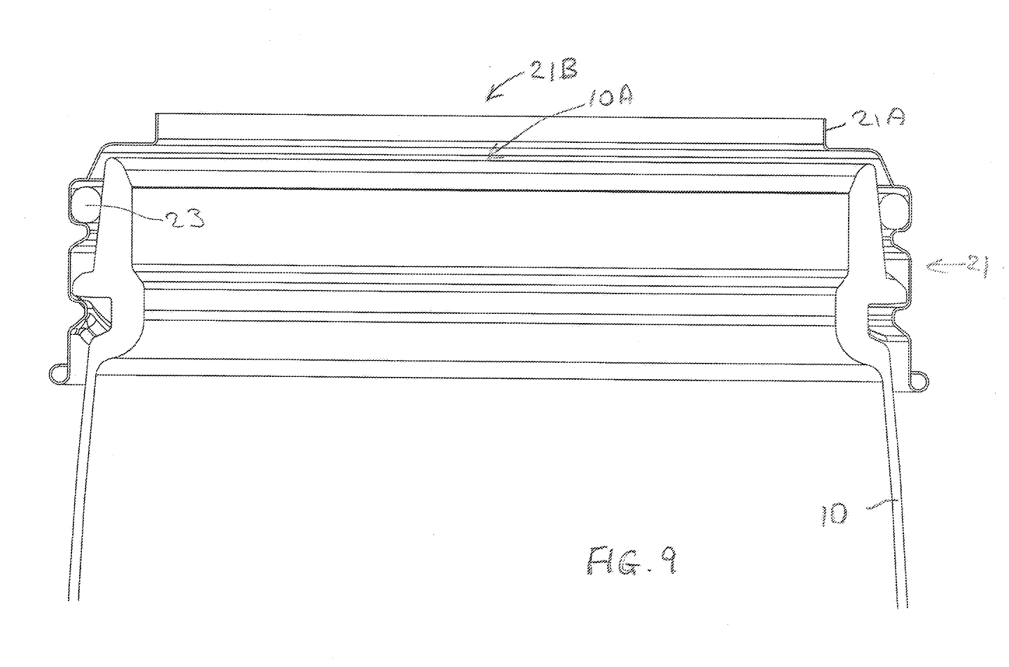

FIG. 8 shows a skirt portion of a second embodiment of a closure according to an aspect of the invention. This is similar to the first embodiment shown in FIG. 1 except that the cylindrical upstand 21A of the skirt portion 21 is of smaller diameter and shorter in the vertical direction than that of FIG. 1.

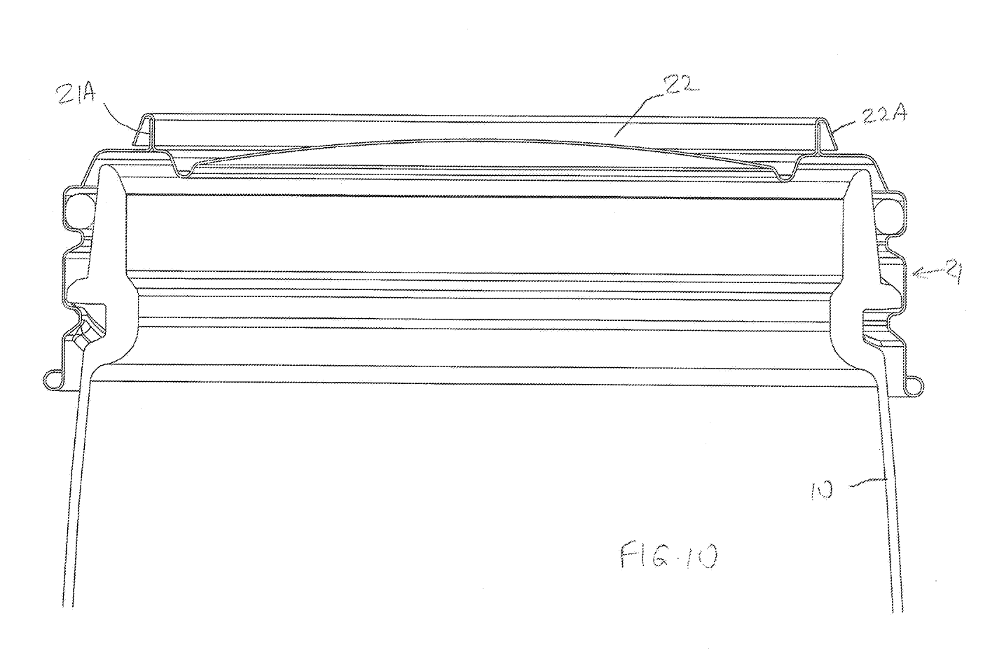

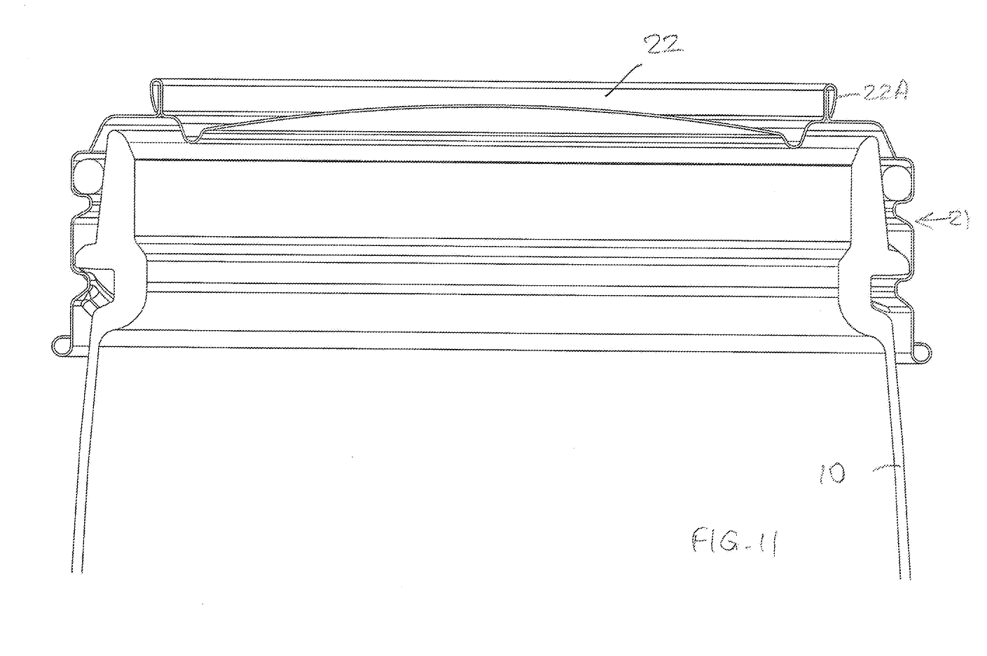

FIGS. 9, 10 and 11 show cross-sectional views corresponding to FIGS. 3, 5 and 6 showing how the closing portion 22 is secured to the cylindrical upstand 21 in the second embodiment. The closing portion is similar to that shown in FIG. 4 but of a slightly smaller diameter to correspond to the diameter of the upstand 21A.

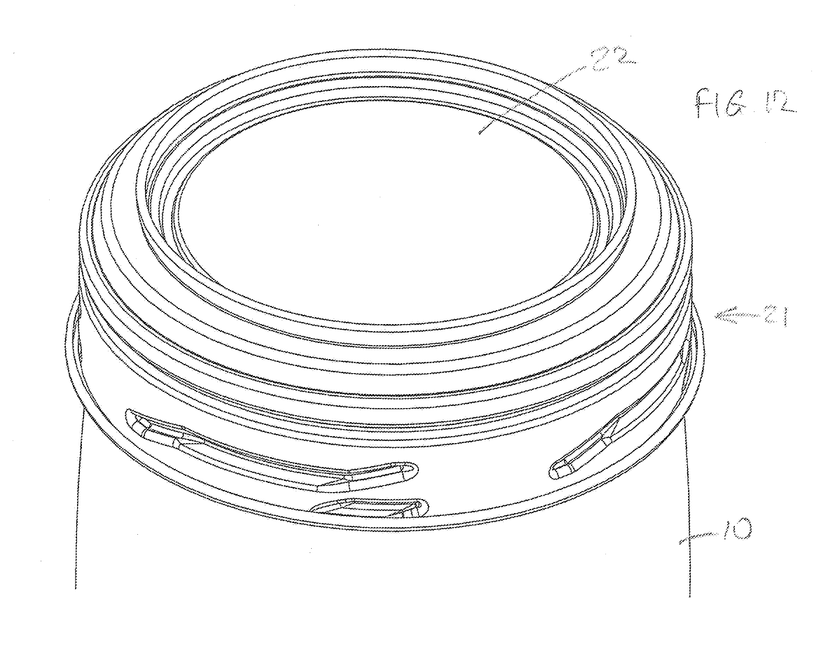

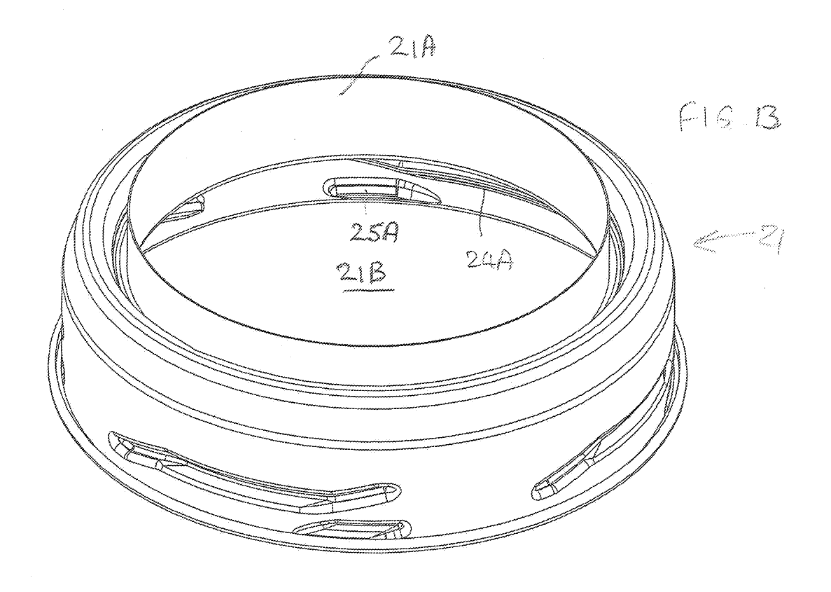

FIG. 12 is a perspective view of the second embodiment of the closure when secured to a container in the position shown in FIG. 11.

The manner in which the skirt portion 21 of the second embodiment is secured to the neck portion of the container 10 is similar to that described above in relation to the first embodiment. Likewise, the manner in which the closing portion 22 is secured to the skirt portion 21 is similar to that described in relation to the first embodiment.

The second embodiment illustrates that the diameter of the opening 21B in the skirt portion 21 can be of different sizes. As indicated above, the opening of a wide mouth container typically has a diameter in the range 45 to 80 mm. Preferably, the diameter of the opening in the skirt portion 21 is at least 80% of the diameter of the opening in the container 10. In some cases (as in the first embodiment) the diameter of the opening in the skirt portion 21 may be greater than the diameter of the opening in the container 10. In a preferred arrangement (not shown), the diameter of the opening in the skirt portion 21 may be substantially similar to the diameter of the opening in the container 10.

One reason for wanting to provided skirt portions 21 of different diameters is that, as mentioned above, the container with a skirt portion 21 mounted thereon is arranged to simulate the body of a can as filled on a conventional can filling and closing line. The diameter of the skirt portion, in particular the upstanding part thereof can thus be arranged to correspond to the diameter of can body that the filling and closing line is designed to handle.

In this connection it should be noted that although the skirt portion is preferably formed of metal (so that it can be secured to a metal closing portion by a seamed joint), the container can be of other materials, ie it is only the cylindrical upstanding part 21A of the skirt portion 21 which needs to simulate the body of a can. The sub-assembly of the container 10 and skirt portion 21 mounted thereon thus behaves like the body of a can and can be filled and closed in an existing can filling and closing line with little or no modification of the line.

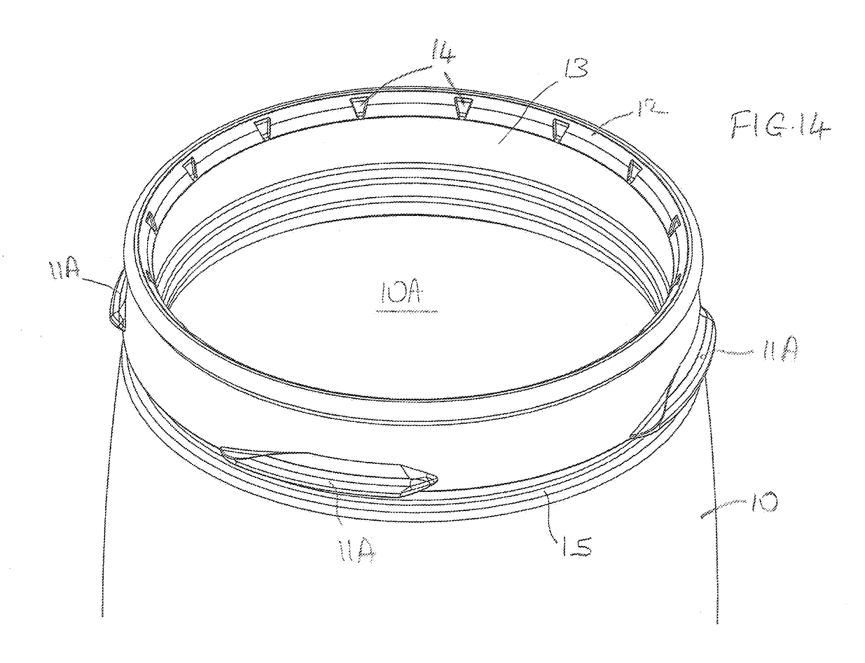

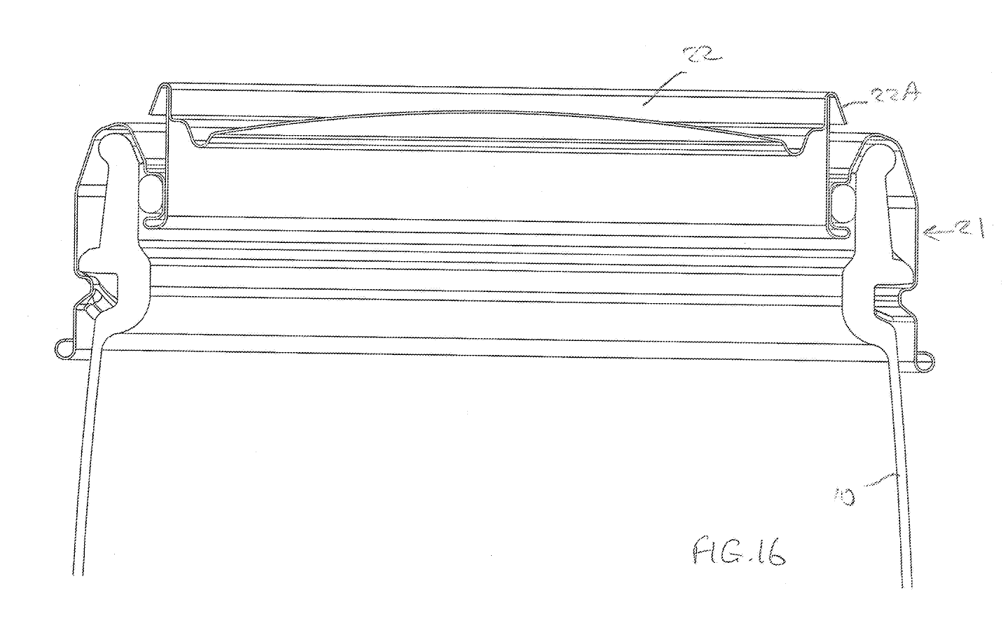

FIG. 13 shows a skirt portion 21 of a third embodiment of a closure according to an aspect of the invention. This is somewhat similar to the second embodiment shown in FIG. 81 except that the o-ring sealing member 23 is mounted in a groove 23B provided in a bore member 22 of the skirt portion 21 so as to engage a sealing surface 13 on the inner surface of the container 10 (as shown in FIG. 15). This is similar to the arrangement described in PCT/GB2015/052154 (except that the closure is fabricated from two parts as described above).

As indicated, the skirt portion 21 has a bore component 22 extending from the underside thereof and which, in use, extends into the container 10. The bore component 22 carries an o-ring so that the o-ring 23 provides a seal between the internal sealing surface 13 of the container 10 and the bore component 22 when the skirt portion 21 of the closure is mounted on the container 10. The o-ring 23 is located in a groove or gland 23A provided on the outer surface of the bore component 22. Further details of a suitable form of o-ring and gland are provided in WO2011/151630 referred to above.

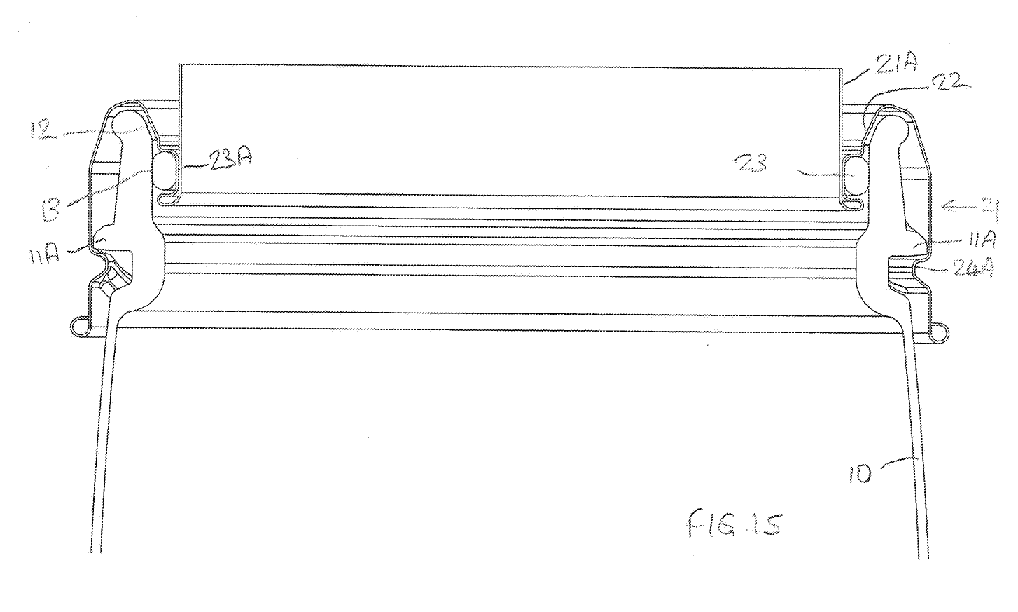

FIG. 14 is a perspective view of the upper part of a further container 10 adapted to receive the skirt portion 21 of FIG. 13. This container 10 has venting grooves 14 formed in an inclined lead-in surface 12. The lead-in surface 12 helps compress/deform the o-ring 23 as it is driven down into the container and into engagement with a sealing surface 13 on the inner surface of the container (again as described in PCT/GB2015/052154). When the closure is in a venting position, the o-ring 23 engages this lead-in surface 12 and the grooves 14 in the lead-in surface help excess pressure in the container escape past the o-ring 23 (again as described in PCT/GB2015/052154).

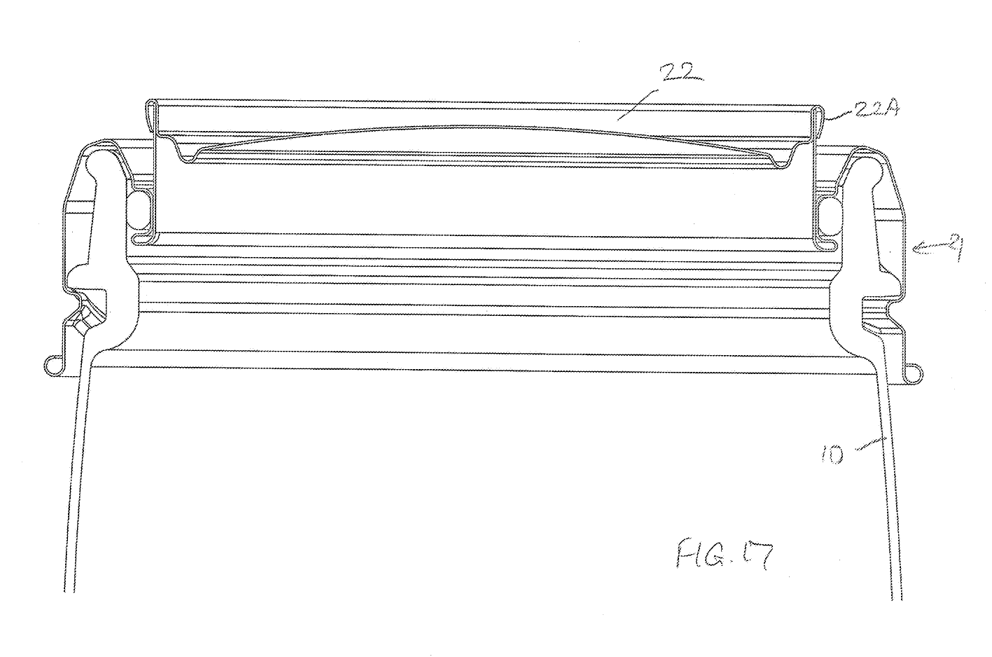

FIGS. 15, 16 and 17 show cross-sectional views corresponding to FIGS. 3, 5 and 6 showing how the skirt portion 21 of FIG. 13 is secured to the cylindrical upstand 21A on the third embodiment. The closing portion 22 is again similar to that shown in FIG. 4 but of a slightly smaller diameter to correspond to the diameter of the cylindrical upstand 21A.

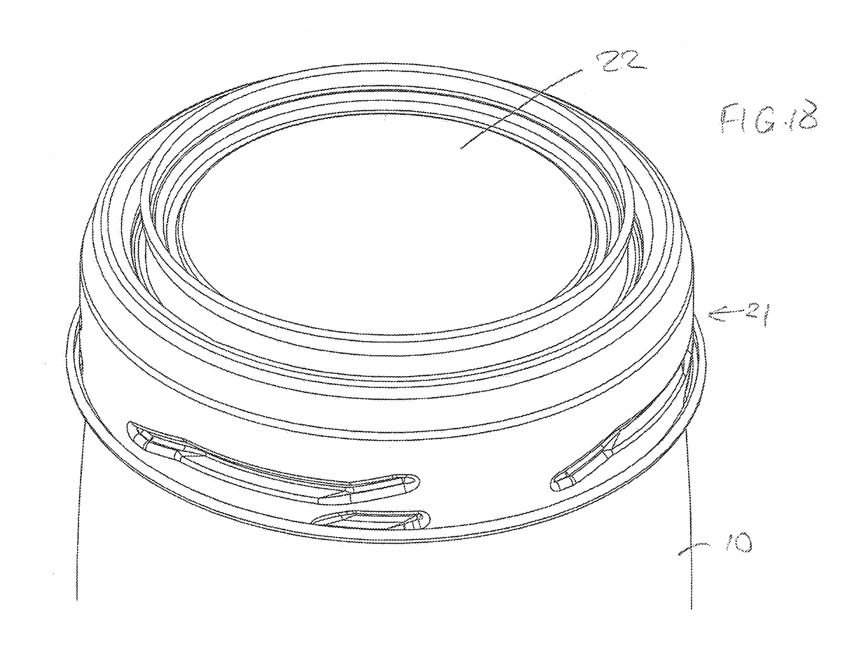

FIG. 18 is a perspective view of the third embodiment of the closure when secured to a container 10 in the position shown in FIG. 17.

It will be seen that in each of the embodiments, the diameter of the releasable securement of the skirt portion 21 to the container 10, ie the diameter of the threadform by which these are secured together, is greater than (as in FIGS. 11 and 17), or substantially similar to (as in FIG. 6), the diameter of the irreversible securement of the closing portion 22 to the skirt portion 21, ie the diameter of the seamed joint. The seamed joint is thus part of the removable closure.

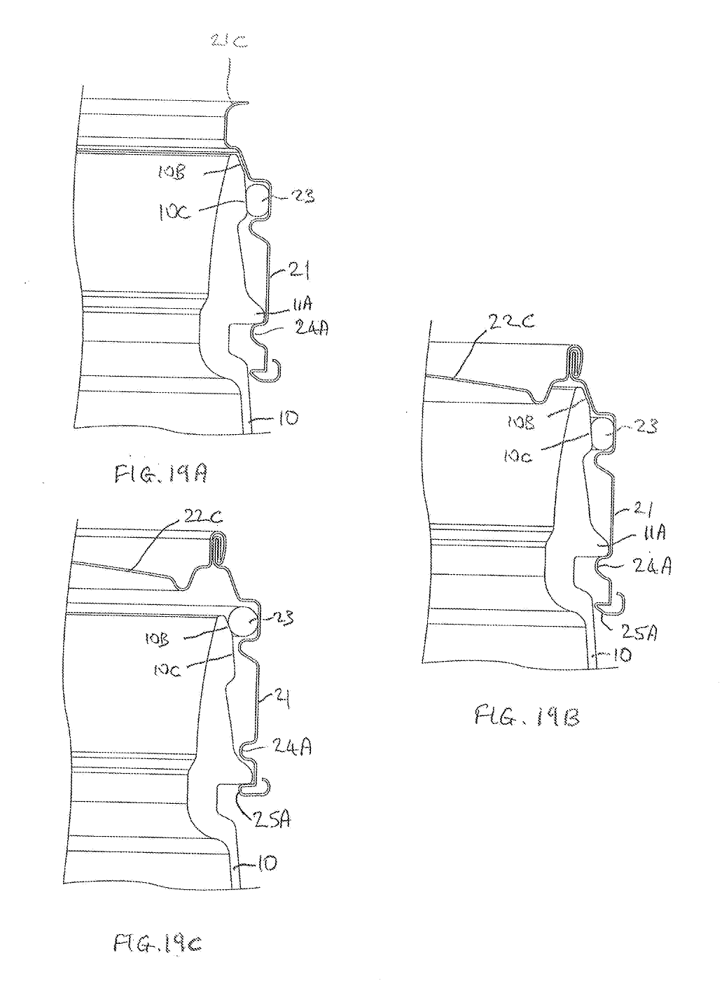

FIGS. 19A, 19B and 19C are cross sectional views of a modification of the embodiment shown in FIG. 3. FIG. 19A shows the skirt part 21 secured to the container 10 in the sealed position prior to the closing part 22C of the closure being secured to the skirt part 21. FIGS. 6, 11 and 17 above illustrated a simple form of seamed joint whereas FIG. 19 shows a more conventional double seamed joint. To form such a joint, the upper end of the cylindrical upstand of the skirt part 21 is typically curved or flared outwardly as shown at 21C in FIG. 19A and in the completed seamed joint this is folded over so that the upper end of the upstanding part 21 is folded into an inverted U-shape as shown in FIG. 19B. The flange at the periphery of the closing portion 22C is also formed into a U-shape which interlocks with the inverted U-shape of the skirt portion 21. The periphery of the closing portion 22C may also undergo a further 180 degree bend to form a further inverted U-shape over the joint as shown in FIG. 19B. This form of double seamed joint is well known and commonly used in securing a can end to a metal can body. The upstanding part 21A of the skirt part shown in the embodiments described above may also be flared out in a similar manner and a double seamed joint formed between the skirt portion and the closing portion.

FIG. 19 also shows another example of a metal closure fitted to a plastic container 10. It also shows more clearly the upper end of the external surface of the container being angled (by about 10 to 30 degrees) to the vertical to provide a surface 10B corresponding to the lead-in surface of the embodiments having an internal o-ring seal. The external sealing surface 10C of the container 10 may be substantially cylindrical (and thus substantially vertical) but may also, as shown in FIG. 19 be at a small angle (typically up to 5 degrees) to the vertical so the diameter of the sealing surface 10C increases slightly further away from the mouth of the container. This helps increase the compression force on the o-ring 23 as the closure moves downwards relative to the container 10 and helps ensure the o-ring 23 is compressed so as to form a good seal if there are any variations in the diameter of the container 10 and/or the skirt portion 21 of the closure due to manufacturing tolerances or variation in the circularity of either part.

FIG. 19B shows the closure in the sealed position on the container 10 with the o-ring seal 23 engaging the external sealing surface 10C of the container. When the closure is rotated in the loosening direction it moves upwards relative to the container (as described in relation to the earlier embodiments) until upward movement is arrested by engagement of the third portions 25A of projections of the closure engage the underside of the first portions 11A of the container. This is the venting position in which the o-ring seal 23 engages the inclined surface 10B at the upper end of the container so the o-ring 23 is no longer compressed so gas can escape from the interior of the container past the o-ring 23.

The container shown in FIG. 19 is also shaped to provide a small shoulder 10D beneath the sealing surface 10C. This provides a transfer feature to enable the closure to be picked up by automatic handling machinery.

As described above, a metal closure may be used to close a container formed of a plastics material (as described above) or other material, eg a metal container or a glass container.

In all embodiments, the sealing means is preferably an o-ring seal, in some cases engaging an external surface of the container and in other cases engaging an internal surface of the container. In either case, in order to function as a true o-ring, the cross-sectional area of the gland should be greater than the cross-sectional area of the o-ring 23 so the o-ring 23 is able to move and/or deform within the gland (eg as illustrated in FIG. 3) so that it provides a sealing function as described in WO2011/151630—rather than simply being a compression seal which happens to have a circular cross-section.

As described in WO2011/151630, an o-ring 23 located within a gland provides a very different sealing function to a compression seal. The o-ring moves and deforms within the gland as the closure is moved into the position shown in FIG. 3. Once in the position shown in FIG. 8B, the o-ring is able to deform further if subject to an increased pressure differential to further enhance the seal between the container and the closure. Such deformation of the o-ring (on fitting of the closure and in response to increases in pressure) is particularly important when the seal provided by the o-ring needs to resist relatively high pressure differentials, eg of several atmospheres (1 atmosphere is approx. 1×10⁵ Pascals) when the container contains a carbonated beverage. In such circumstances (as described further in WO2011/151630), the compression ratio of the o-ring is preferably in the range 20-25% and the gland fill in the range 50-90% and preferably in the range 65-85%.

Although an o-ring seal has many advantages, particularly for wide mouth containers housing carbonated beverages (or other pressurised contents), other forms of sealing means may be used in other applications, particularly those not requiring a high performance seal.

In the embodiments described above the first, second and third portions are each equi-angularly spaced around the circumference of the container and closure. However, it would be possible for these to be non-uniformly spaced, eg if it is desired to provide a large spacing between the portions in one or more areas so as to provide a more comfortable are to drink from.

The illustrated embodiments each have four first portions (and four second portions and four third portions) but, as indicated, a smaller or greater number may be used depending on the diameter of the closure and container and the pressure the closure is designed to withstand. An arrangement with six first portions and six second portions (and six third portions if provided) is another option.

The lower surfaces of the first portions and the upper surfaces of the second portions are preferably substantially flat, or have a flat portion, in the radial direction. However, in some embodiments, eg on a bottle neck, these surface may be angled or curved in the radial direction so long as the interaction between the surfaces in the vertical direction is sufficient to provide the required securement of the closure on the container in the vertical direction.

In the embodiments described, the first portions preferably have a simple and relatively smooth shape so as to minimise their impact on the appearance of the container and their impact on the user's lips whereas the second (and optionally third) portions on the closure may have a more complex shape as they do not come into contact with the users lips and as they are concealed to some extent on the inner surface of the closure. However, in situations where these factors are of less concern, the first portion may have a more complex shape. One possibility is for the downwardly and upwardly angled ends of the second portions to be provided instead on the first portions. Another possibility would be for the first portions to be provided on the closure and the second portions on the container.

For carbonated applications in particular, the upwardly angled ends may also be omitted if the pressure within the container is relied upon to assist the user in lifting the closure once the engagement of the third portions beneath the second portions has been released.

For single use applications, eg in which the entire contents of the container are intended to be consumed in one go, the downwardly angled ends of the second portions may be omitted. This makes it much more difficult for a user to re-close the container once opened as a considerable axial force needs to be applied to the closure in order to compress/deform the o-ring as it moves into engagement with the sealing surface. The user is thus deterred from attempting to re-close the container. This may be desirable when the contents of the container are susceptible to rapid deterioration and the quantity provided is designed to be used in one go. In such an application the additional force required to compress/deform the o-ring as the skirt portion is mounted on the container is provided by a machine (eg a capping machine) during assembly thereof in an industrial process but relatively difficult to apply by hand. The fact that the container cannot be re-closed by hand in this arrangement also provides a tamper evident feature.

For a container housing a carbonated beverage, the circumferential length of the substantially horizontal upper surfaces of the second portions is preferably substantially the same as the circumferential length of the substantially horizontal lower surfaces of the first portions.

Also, each first portion preferably has a circumferential length substantially similar to the circumferential length of said elements of the second portions and preferably said elements of the second portions are in contact with substantially the entire circumferential length of said lower surfaces of said first portions when the closure is secured to the container.

For a wide-mouth container housing a carbonated beverage, the combined circumferential lengths of the first portions is preferably substantially half the outer circumference of the container at the position at which the first portions are provided thereon.

As mentioned above, at least for carbonated applications, the combined circumferential length of the first portions is preferably about 50% of the external circumference of the container and in the secured position the second portions are in contact with substantially the entire circumferential length of the lower surfaces of said first portions. For non-carbonated application in particular, but also when both cap and container are made from a stronger material (eg some metals) which is less liable to deformation, the combined circumferential length of the first portions (and of the second portions) may be less but is preferably at least 15-25% of the external circumference of the container (or closure) to help ensure the closure is securely held on the container (as it may still be subject to a pressure differential due to temperature changes or to reduced external pressure). Also, if the gaps between the first portions or second portions become too large, there is a risk that the closure may distort to a non-circular shape which can prejudice the seal between the container and the closure.

Similarly, the second portions may be in contact with less than the entire circumferential length of the lower surfaces of said first portions. However, the length of contact should be sufficient to enable the surfaces to slide over each other and sufficient to withstand the pressure to which the closure will be subjected to without the second portions becoming indented in, or otherwise damaging, the first portions.

It will also be appreciated from the embodiments described above that the circumferential spacing between the first portions must be sufficient to allow the second portions to pass therebetween. Although the second portions may have one or more inclined ends, and these may pass at an angle between the first portions, the horizontal elements of the second portions must be shorter than the circumferential spacing between the first portions (whether they pass vertically or at an angle through the gaps therebetween).

As mentioned above, in a preferred form of the invention the container may be formed of metal, eg as used in conventional beverage cans. The thread forms on the neck portion of such a metal container may be formed directly in the wall of the container, eg by rolling and/or pressing operations (or other conventional metal forming techniques). In other cases it may be desirable to form the thread forms in a separate annular collar portion which is then be attached to the upper portion of the container (either before or after forming the thread forms therein), eg by means of a seamed joint. This may be desirable when, for example, the upper end of the container is too flexible or not sufficiently robust for the thread forms to be formed directly therein. References herein to the neck portion of a container include both the upper portion of an open-ended container and an annular collar secured to the upper end of an open-ended container which then provides the neck portion of the container.

For the avoidance of doubt, the verb “comprise” as used herein has its normal dictionary meaning, ie to denote non-exclusive inclusion. The use of the word “comprise” (or any of its derivatives) does not therefore exclude the possibility of further features being included.

All of the features disclosed in this specification (including the accompanying claims, and drawings) may also be combined in any combination (other than combinations where the features are mutually exclusive).

Each feature disclosed in this specification (including the accompanying claims and drawings) may be replaced by alternative features serving the same, equivalent or similar purpose, unless expressly stated otherwise. Thus, unless expressly stated otherwise, each feature disclosed is just an example of a generic series of features providing an equivalent or similar function.

The invention is not restricted to the details of the embodiments described. The invention extends to a container and/or closure which comprises one or more of the features referred to above, or any other novel concept, feature, or combination of the features disclosed herein.

1. A method of forming a releasable closure for a container having a substantially circular opening, the method comprising releasably securing an annular skirt portion of the closure to a neck portion of the container, subsequently locating a separate closing portion of the closure over an opening in the skirt portion, and irreversibly securing the closing portion to the skirt portion so as to form a closure that closes the opening of the container but is releasable therefrom by disengaging said skirt portion from the neck portion of the container.

2. A method as claimed in claim 1 in which the skirt portion of the closure and the neck of the container have mutually engageable thread forms whereby the closure can be releasably secured to the container by rotation relative thereto, preferably through less than 360 degrees.

3. A method as claimed in claim 1 in which the closure is formed of metal.

4. A method as claimed in claimed in claim 3 in which the closing portion is irreversibly secured to the skirt portion by a seamed joint.

5. A method as claimed in claim 1 in which material is passed into the container after the skirt portion has been releasably secured to the container neck and prior to the closing portion being irreversibly secured to the skirt portion.

6. A closure for releasably closing a substantially circular opening of a container, the closure comprising two, initially separate, components: an annular skirt portion adapted to be releasably secured to a neck portion of the container and a closing portion adapted to be irreversibly secured to the skirt portion so as to close an opening therein after the annular skirt portion has been releasably secured to the neck portion of a container.

7. A closure as claimed in claim 6 in which the skirt portion of the closure and the neck of the container have mutually engageable thread forms whereby the closure can be releasably secured to the container by rotation relative thereto, preferably through less than 360 degrees.

8. A closure as claimed in claim 7 in which the thread forms comprise a plurality of circumferentially spaced first projections on the container neck and a plurality of circumferentially spaced second projections on the skirt portion neck, each the first and second projections comprising a substantially horizontal part, the second projections on the skirt portion being able to pass between the first projections on the container neck and then locatable beneath the first projections on the container neck.

9. A closure as claimed in claim 8 in which at least some of the second projections have a downwardly inclined part at a first end of the horizontal part and/or an upwardly inclined part at a second end of the horizontal part such that upon rotation of the closure relative to the container in a first direction, said downwardly inclined parts act to drive the closure downwards relative to the container and/or upon rotation of the closure relative to the container in a second direction, said upwardly inclined parts act to drive the closure upwards relative to the container.

10. A closure as claimed in claim 6 formed of metal.

11. A closure as claimed in claim 10 in which the closing portion is irreversibly secured to the skirt portion by a seamed joint.

12. A closure as claimed in claim 11 in which the seamed joint is formed between an upstanding part of the skirt portion and a substantially circular edge part of the closing portion.

13. A closure as claimed in claim 6 in which the skirt portion of the closure is releasably secured to the container at a location having a diameter greater than or substantially equal to the diameter of the location at which the closing portion is irreversibly secured to the skirt portion.

14. A closure as claimed in claim 6 in which the skirt portion of the closure has an o-ring seal located within a groove formed therein and arranged to provide a seal between the skirt portion and an external surface of the container neck when the skirt portion is releasably secured to the container neck.

15. A closure as claimed in claim 6 in which the skirt portion of the closure has a bore member which projects into the container opening when the skirt portion is releasably secured to the container neck and has an o-ring seal located within a groove formed in the bore member and arranged to provide a seal between the skirt portion and an internal surface of the container neck when the skirt portion is releasably secured to the container neck.

16. A closure as claimed in claim 6 which is moveable relative to the container between a first secured position thereon in which it is in sealing engagement with the container and a second secured position thereon in which venting of the container can occur.

17. A closure as claimed in claim 7 in which the closure has a plurality of third circumferentially spaced projections arranged to engage beneath the first projections on the container neck once the second projections have disengaged therefrom and the closure has move upwards relative to the container to release the sealing engagement therebetween.

18. A closure as claimed in claim 6 releasably secured to a container which has been filled with a material.

19. A closure as claimed in claim 18 in which the container is formed of metal or a plastics material.

20. A container having a substantially circular opening and having an annular skirt portion of a releasable closure releasably secured to a neck portion of the container, the container being fillable through an opening in the skirt portion, the skirt portion being adapted to have a closing portion irreversibly secured thereto, after the container has been filled, so the closure closes the opening of the container but is releasable therefrom by disengaging said skirt portion from the neck portion of the container.

21. A container as claimed in claim 20 in which the skirt portion of the closure and the neck of the container have mutually engageable thread forms whereby the closure is releasably secured to the container by rotation relative thereto, preferably through less than 360 degrees.

22. A container as claimed in claim 20 in which the thread forms comprise a plurality of circumferentially spaced first projections on the container neck and a plurality of circumferentially spaced second projections on the skirt portion neck, each the first and second projections comprising a substantially horizontal part, the second projections on the skirt portion being able to pass between the first projections on the container neck and then locatable beneath the first projections on the container neck.

23. A container as claimed in claim 22, having a tamper evident feature comprising one or more blocking members locatable in one or more gaps between said first projections once said second projections are located beneath said first projections so as to prevent said second projections from being aligned with and/or passing through said gaps until the blocking feature is moved out of said one or more gaps.

24. A container as claimed in claim 20 in which the container and the skirt portion of the closure are formed of metal.

25. A container as claimed in claim 20 in which the container is formed of a plastic material and the skirt portion of the closure is formed of metal.

26. A method of filling a container comprising the steps of providing a container having a substantially circular opening and having an annular skirt portion of a releasable closure releasably secured to a neck portion of the container, filling the container through an opening in the skirt portion, subsequently locating a separate closing portion of the closure over the opening in the skirt portion, and irreversibly securing the closing portion to the skirt portion so as to form a closure that closes the opening of the container but is releasable therefrom by disengaging said skirt portion from the neck portion of the container.

27. A method as claimed in claim 26 in which the diameter of the container opening is in the range 45 to 80 mm.

28. A method as claimed in claim 26 in which the opening in the skirt portion has a diameter of at least 80% of the diameter of the container opening.
